(19) United States
(12) Patent Application Publication
(10) Pub. No.: US 2025/0317701 A1
(43) Pub. Date: Oct. 9, 2025

(54) Optimization of loudspeaker installation in a monitoring space

(71) Applicant: Genelec Oy, Iisalmi (FI)

(72) Inventors: Juha Holm, Iisalmi (FI); Aki Mäkivirta, Iisalmi (FI); Mikko Roininen, Iisalmi (FI)

(21) Appl. No.: 18/866,572

(22) PCT Filed: May 17, 2023
(86) PCT No.: PCT/FI2023/050276

§ 371 Date: Nov. 18, 2024

(30) Foreign Application Priority Data
May 17, 2022 (FI) 20225433

(51) Int. Cl. H04R 29/00

(52) U.S. Cl. CPC H04R 29/002

(57) ABSTRACT

According to an example aspect of the present invention, there is provided a method of producing a report for optimizing an installation of a loudspeaker system comprising said at least one loudspeaker in a monitoring space. The disclosed method involves providing audio data representative of the performance of the loudspeaker system, performing an analysis, wherein a value for at least one audio parameter from the audio data is analysed processed into results, and outputting the compiled results.

### FIELD

The present disclosure relates to sound reproduction. In particular, the present disclosure relates to optimizing installation of loudspeakers that have been calibrated for a particular monitoring space.

### BACKGROUND

It is generally known in the art to calibrate loudspeakers to a monitoring room. Conventional calibration procedures typically include reproducing a test signal with a set of loudspeakers, capturing the reproduced test signal with a microphone, then analysing the signal and equalizing the signal inputted to the loudspeakers to balance out imperfections of the room that cause peaks or dips in the frequency response curve, for example. One such a calibration method and system is disclosed in U.S. Pat. No. 10,924,874 B2.

A method and system of statistically optimizing a loudspeaker system to one or more than one potential listening spot is disclosed in US2005031135 A1. In the method a test signal is produced with a loudspeaker system, and a transfer function is deduced from the measurement results of the test signal. The transfer function is modified as a calculation exercise to simulate different loudspeaker installation configurations, such as positioning or adjustment, to anticipate the effect of said different configurations to the output of the sound. In other words, the core concept of US2005031135 A1 is analyzing variables in the selected audio system that theoretically affect performance.

US2018359583 A1 discloses a system for monitoring a listening room such devised to perform periodical verifying measurements to ascertain that output of the loudspeaker system has remain unaltered since installation. The system and method is based on producing a test signal with the loudspeaker system and measuring the output. If the system of US2018359583 A1 concludes that the loudspeaker system is no longer producing the original output, the user is alerted to inspect the listening room and to investigate, which components have failed.

Automated room performance reports are also known from “biamp-Launch report card” and from “Biamp Launch Report Card-Biamp Cornerstone”.

These automated room performance reports feature an analysis of certain audio parameters in the room, in which the audio system was tested.

Finally, WO 2010135294 A1 discloses a system for automatically tuning an audio system to achieve a target acoustic response while maintaining a determined level of power efficiency. The system features a processor-executed engine to establish (a) performance related data, which represents cooperative operation of loudspeakers, (b) a target acoustic response and a power efficiency weighting factor, which represents of a desired degree of power efficiency, and (c) operational parameters, which are based on the target acoustic response, performance related data and impedance data. The engine provides operational parameters to balance optimized acoustic performance and optimized power efficiency of the loudspeakers based on the power efficiency weighting factor.

While modern calibration systems are sophisticated and effective, there remains a desire to further optimize a loudspeaker system to the listening room.

### SUMMARY

The invention is defined by the features of the independent claims. Some specific embodiments are defined in the dependent claims.

According to a first aspect of the present disclosure, there is provided a method of producing a report for optimizing an installation of a loudspeaker system comprising said at least one loudspeaker in a monitoring space. The disclosed method has the following steps:
providing audio data representative of the performance of the loudspeaker system,
performing an analysis, which comprises:
   extracting a value for at least one audio parameter from the audio data,
   comparing the extracted value to a criteria database, which comprises a tolerance for the at least one audio parameter,
   if the value being analyzed is within the associated tolerance, storing an indication of compliance for the corresponding audio parameter,
   if the value being analyzed is not within the associated tolerance, querying a helper database for an installation suggestion for said value as well storing an indication of non-compliance for the corresponding audio parameter and the associated installation suggestion, and
   compiling the stored results, and
outputting the compiled results.

According to a second aspect of the present disclosure, there is provided a method of producing a report for optimizing an installation of a loudspeaker system comprising said at least one loudspeaker in a monitoring space. The disclosed method involves the following steps:
providing a plurality of audio data sets representative of the performance of the loudspeaker system in a corresponding plurality of different installations,
performing an analysis, which comprises:
   extracting a value for at least one audio parameter from the plurality audio data sets,
   comparing each of the values extracted from the plurality audio data sets to each other and to a predetermined target value,
   based on the comparison step, selecting the audio data set, which has a value of the least one audio parameter closest to the predetermined target value, as the recommended installation, and
   compiling the stored results, and
outputting the compiled results.

According to a third aspect of the present disclosure, there is provided a computing system having a processor and a memory, which is connected to the processor. The memory has stored thereon a set of computer readable instructions causing, when executed by the processor, the processor to perform the above-listed processing steps. The computing system also includes a data communication interface, which is connected to the processor for receiving audio data from and to a sound reproduction system. The computing system further includes a criteria database directly or indirectly connected to the processor. The criteria database contains a library of tolerances for at least one audio parameter. The computing system further includes a helper database, which is directly or indirectly connected to the processor. The helper database contains a library of installation change suggestions for a plurality of pre-determined non-compliances with tolerances for the at least one audio parameter.

According to a fourth aspect of the present disclosure, there is provided a non-transitory computer readable medium having stored thereon a set of computer readable instructions that, when executed by at least one processor, cause an apparatus to perform the above-listed processing steps.

According to a fifth aspect of the present disclosure, there is provided a computer program configured to cause the above-described method to be performed on a computing unit.

One or more embodiments may include one or more features from the following itemized list of features:
the analysis step comprises performing an analysis on a plurality of audio parameters,
the analysis step is performed at least in part in an computing system, which is external to the sound reproduction system,
the computing system is connected to the loudspeaker system through a data communication interface between the computing system and a control system, which is connected to the loudspeaker system;
the method includes a calibration step;
the calibration step involves a test signal step comprising reproducing an audio test signal with at least one loudspeaker;
the calibration step involves in a listening step comprising capturing the reproduced audio test signal with a microphone located in the monitoring space;
the calibration step involves calibrating the loudspeaker system based on the captured audio test signal;
the method comprises a second such calibration step;
the audio parameter is selected from a list comprising or consisting of:
   frequency response,
   −6 DB points,
   time of flight,
   summation of frequency response of a plurality of loudspeakers,
   subwoofer high cut-off frequency,
   low frequency dip in (full bandwidth) monitors,
   early to late sound ratio,
   decay time of room mode,
   subwoofer and (full bandwidth) monitor sum response dip,
   early reflection level, and
   reverberation time (RT60);
the outputting step comprises displaying compliance of each audio parameter to a pre-determined criteria set for those parameters,
the computing steps are performed in an external computing system, such as a cloud-based computing system, and wherein the adjustment step is performed physically in the listening space.

The present inventive concept caters for data-based and convenient optimization the physical installation of loudspeakers to a listening room. Previously loudspeakers could be equalized with pre-sets to mitigate imperfections brought on by the physical limitations of the listening room. While a competent installation professional could certainly improve the performance of the room and loudspeakers as a whole, the present concept provides educated improvement suggestions to the installation that do not require prior experience and that are based on verifiable data. Optionally, the compliance of the installation to a given audio standard may be established.

### BRIEF DESCRIPTION OF THE DRAWINGS

In the following certain exemplary embodiments are described in greater detail with reference to the accompanying drawings, in which:

FIG. 1 illustrates a block diagram of a system for optimizing installation of a multi-loudspeaker system in accordance with at least some embodiments of the present invention and

FIG. 2 illustrates a flow diagram of main actions of an exemplary calibration and analysis steps in accordance with at least some embodiments of the present invention.

### EMBODIMENTS

In the present context, the term “installation” includes but is not limited to the physical setup of loudspeakers in a listening room. Physical parameters of an installation include distance from the selected listening spot, distance from the acoustic center axis, toe in, distance from a “back wall”, use of absorption material between the loudspeaker enclosure and the supporting surface, type of stand or mount, etc.

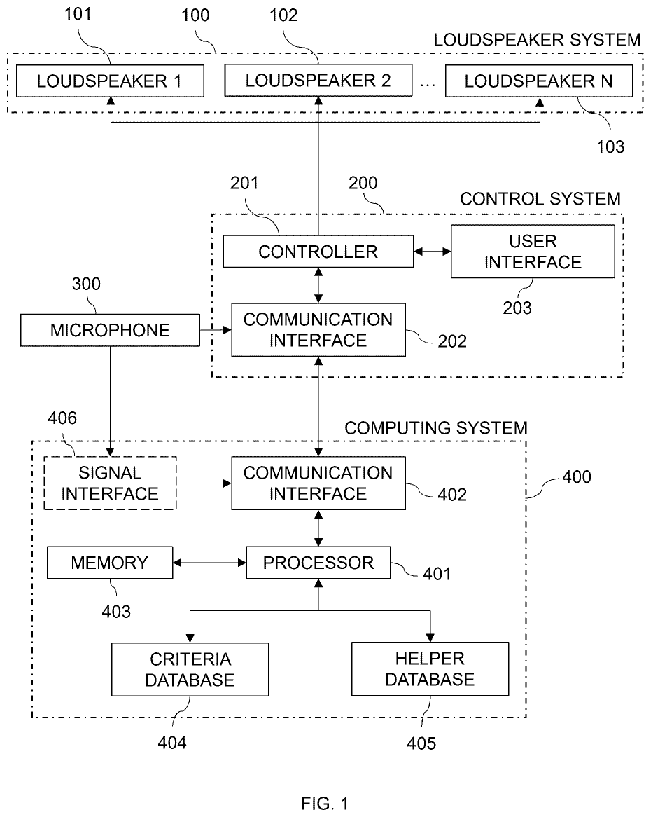

FIG. 1 illustrates a simplified block diagram of a system used to optimize installation of a loudspeaker system 100 in a listening room. A typical loudspeaker system 100 comprises at least two loudspeakers. FIG. 1 denotes the presence of a first loudspeaker 101, a second loudspeaker 102, and an nth loudspeaker 103 for highlighting the irrelevance of the exact number of loudspeakers in the loudspeaker system 100 as concerns the present invention.

The loudspeaker system 100 is controlled by a control system 200, which is connected to the loudspeaker system 100. The control system 200 may be constructed as a unit or it may be formed by an interconnected network of dedicated devices. The exemplary control system 200 includes a controller 201, which may take the form of a tuner amplifier. The controller 201 may be connected to the loudspeakers 101 . . . 103 directly with cables or through a network, such as a local area network. Such devices are known per se. The control system 200 has a user interface 203 for commanding the controller 201. The user interface 203 may take the form of a control panel on the tuner amplifier of a graphical user interface included in the tuner amplifier or one being computer based and connected to the controller through a network. Such devices are known per se. For accessing the controller the control system 200 has a communication interface 202, which should be understood broadly so as to mean any galvanic and/or wired or wireless data interfaces for communicating with the controller 201 and, ultimately, the loudspeaker system 100.

A computing system 400 is also provided for analysing the performance of the loudspeaker system 100 in the listening room. The computing system 400 may be a separate cloud or locally run processing system connected to the control system 200 through a data network as shown in FIG. 1 or it may be incorporated into the control system 200 such as being embedded into a memory and run by an associated processor of the controller (not shown). According to the illustrated embodiment, the computing system 400 is a cloud-driven processing unit having a communication interface 402, which may take the form of a communication port open to the internet or other data network. The communication interface 402 is directly or indirectly connected to a corresponding communication interface 202 on the control system 200. The communication interface 402 is connected to a processor 401, which should be understood functionally as data processing resources provided locally or as cloud computing. The processor 401 is connected to a memory 403 for storing software required for the data analysis, which will be explained in greater detail here after. The computing system 400 also includes a first database 404, which includes a library of acceptable criteria for audio parameters. The library may include one or more than one criteria according to one or more than one standard or other list of requirements. One exemplary audio quality standard is ITU-R BS.1116, which is a quality recommendation for broadcasting services describing high precision audio listening conditions for the monitoring applications like recording studios, post production and audio editing. The first database 404 may in practice be included in the memory 403 or in a remotely accessed memory. In the illustration of FIG. 1 the first database 404 is drawn as a separate entity purely for illustrational purposes. The computing system 400 further includes a second database 405, which includes a library of pre-defined loudspeaker setup instructions associated with similarly pre-defined non-conformities with said acceptable criteria. In practice the second database 405 may be stored in the same memory as the first database 404 or it may form part of the first database 404 or vice versa. According to the illustrated example the second database 405 is a locally stored or remotely accessed database separate to the first database 404.

The computing system 400 may be constructed as a separate unit or physically built into the control system 200. If constructed as a separate unit, the computing system 400 may include a signal interface 406, such as a microphone jack or as a wireless audio signal interface.

A microphone 300 is provided to the listening room for capturing sound signals produced by the loudspeaker system 100. The microphone 300 may be connected to the controller 201 through the communication interface 202. The connection may be wired or wireless. Additionally or alternatively the microphone 300 may be connected to an computing system 400 through the signal interface 406.

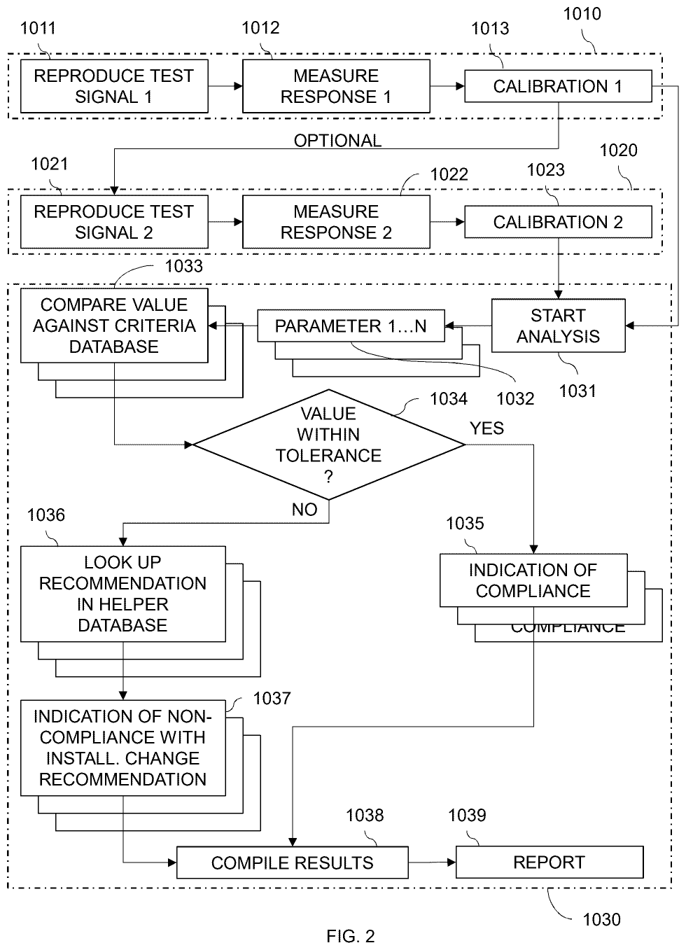

Let us now consider the process of loudspeaker installation in view of the flow diagram of FIG. 2, which shows an exemplary analysis process performed with, for example, the system of FIG. 1.

As a first calibration step 1010, the controller 201 drives each loudspeaker 101, 102, 103 of the loudspeaker system 100 separately or in tandem to reproduce a (first) pre-determined audio test signal 1011. The test signal file may be included in a memory of the control system 200 or accessed remotely. Alternatively the loudspeakers 101, 102, 103 may include such a test signal file locally stored thereon. It is preferred that the controller 201 commands the loudspeakers 101, 102, 103 to “test squawk” separately to avoid interference. After each reproduced test signal the loudspeaker output is captured 1012 by the microphone 300 placed in the listening room, preferably in the desired listening spot. The captured test signal is stored to memory (not shown) of the control system 200 or directly to the memory 403 of the computing system 400 or to an external memory connected to either system. After all loudspeakers 101, 102, 103 or a selected few of the loudspeakers in the loudspeaker system 100 have produced a sample, an analysis is performed for the audio data, which is known per se. The loudspeaker system 100 is then calibrated 1013 by the controller 201, which is also known per se.

After the first calibration step 1010 it is possible, i.e. optional, to perform a second such calibration step 1020, which includes similar actions as the first one, namely reproduction of a test signal 1021 with the loudspeaker system 100, measuring a response 1022 with the microphone, and calibration 1023 based on the test signal data.

In theory, more than two calibration steps are foreseeable.

With the loudspeaker system 100 calibrated for the occupied listening room, the loudspeaker system 100 is optimized as far as equalization can reach. To optimize the physical loudspeaker installation, the calibration, be it in a single stage or multiple stages, is followed up or preceded by an installation analysis 1030 which, according to the exemplary embodiment, is performed in a remote accessed cloud service separate from the control system 200 and loudspeaker system 100.

The calibration 1010, 1020 will produce an audio data file representing the performance of the loudspeaker system 100 in the present listening room. The audio data file may be pre-processed or include raw audio data. The audio data is transmitted by the communication interface 202 of the control system 200 and received by the cooperative communication interface 402 of the computing system 400, where after the analysis is started 1031. The audio data may be streamed between the control system 200 and the computing system 400 using conventional streaming methods or recorded audio files, such as .WAV files, may be transmitted using conventional data transfer methods. First, the audio data file is processed to either extract a set of audio parameters 1 . . . n from raw data or identified from pre-processed data. Relevant audio parameters include conventional frequency response data sets, especially peaks and dips therein, −6 dB points, time of flight, early reflections, early sounds, late sounds, reverberation time (RT60). Extraction of such parameters from an audio file is known per se. Preferably at least the parameters defined in ITU-R BS1116. According to ITU-R BS1116, the quality of audio listening conditions is defined, at least in part, by early reflection level in dB, reverberation time (RT60), deepest notch in frequency response below 300 Hz in dB, and the relationship between early and late reflections in dB.

With the parameters 1 . . . n established, a criteria database 404 is queried for comparing the values of the audio data file against criteria for those parameters 1 . . . n stored in the criteria database 404. The criteria may, for example, be those defined in ITU-R BS1116. Next, in determination step 1034 the compliance of the values of the selected parameters 1 . . . n is established.

If a value is within the tolerance according to the criteria database 404, an indication of compliance is stored 1035 for each compliant value. The indication of compliance preferably includes data on the value of a given parameter and an indication, how well the value meets the associated tolerance for that parameter. For example, in the loudspeaker system the first loudspeaker 101 could have an early reflection value of −10.3 dB, which is classified as “excellent” according to the tolerance, whereas the second loudspeaker 102 could have a corresponding value of −6.5 dB, which is classified as “good”.

If a value is not within the tolerance according to the criteria database 404, the process proceeds to seeking assistance for improving the physical loudspeaker installation so as to bring the loudspeaker into full or improved conformity with the criteria. For each value outside specification, the helper database 405 is queried 1036. The query may be in a single stage or it may involve advancing through a complex series of combined conditions.

The helper 405 database includes a library of pre-determined installation change recommendations associated with a range of non-complying values for the selected parameters. The recommendations may involve one or more of the following elements: position or the loudspeakers, orientation (tilt, toe) of the loudspeakers, location of the listening location, room acoustics, such as use of dampening material, resonators, diffusors, etc.

In the following certain practical examples of audio parameter criteria and installation change recommendations associated with such criteria are disclosed in greater detail.

For example, if the tolerance for early reflections was set at −5 dB, the library could include a pre-determined installation change recommendation for those loudspeakers that fail to produce a value smaller than the threshold value of −5 dB. Let us assume that the second loudspeaker 102 would produce an early reflection of −4.5 dB, the library could include the following installation change recommendation: “Monitor 102 shows a high early reflection level. This can change the sound colour and alter imaging. The time difference between the direct sound and the early reflections tells you the difference in acoustic path distance between the two. Recommendation: To reduce the early reflection level, there are several options. Move the monitors further away from the reflecting surfaces and/or move, turn, tilt or remove the reflecting surface to eliminate the early reflection, and/or add absorbance or diffusion materials to the reflecting surface, to reduce the level of the early reflection.”

As another example, if the tolerance for summing of the acoustical pressure for a plurality of loudspeakers was set at −2 dB, the library could include a pre-determined installation change recommendation for those loudspeakers that fail to produce a value larger than the threshold value of −2 dB. The threshold value in dB is relative to an ideal sound pressure sum, which theoretically is 0 dB. The sound pressure sum may be calculated for any number of loudspeakers.

Let us assume that the loudspeaker system 100 as a whole would produce a summing value of −3 dB, the library could include the following installation change recommendation: “The sound output from these monitors does not sum correctly in phase at all frequencies. This can move or change the sound images in the sound stage, and the summation of the sound level may not be correct at all frequencies, altering sound colour. The reason for poor summation is that sounds from the left and right monitors are not in phase. This can happen because of differences in the time of flight for audio, or because the phase responses of the monitors do not match at all frequencies. Recommendation: Study the acoustic imaging of the monitors. Are you satisfied with the imaging? To improve the situation, check that the monitor locations and the aiming of the monitors are both symmetric relative to the left-right symmetry axis in the room, and that the distances to the acoustically hard surfaces are similar for the left and the right side stereo pair monitors in the room. Are there non-symmetrical acoustically reflecting surfaces in the room? If you cannot move these surfaces by rearranging the monitors, try absorbing or diffusing the acoustic reflections. If you selected the ‘individual calibration’ mode in GLM AutoCal, try using the ‘symmetric’ calibration mode.”

As a further example, if the tolerance for upper or high cut-off frequency of a subwoofer was set at 90 Hz, the library could include a pre-determined installation change recommendation for a subwoofer that fails to produce a value higher than the threshold value of 90 Hz. Let us assume that a subwoofer would produce a cut-off frequency of 80 Hz, the library could include the following installation change recommendation: “The subwoofer high corner frequency is too low. There could be a reduction in audio level close to the high corner frequency affecting the subwoofer crossover performance. The nearest-wall reflections are a typical cause of such problems. Recommendation: Try moving the subwoofer closer to the nearest wall. Consider rotating the subwoofer so that the driver faces the wall, as this is even more effective in removing the effects of the nearest wall cancellation. Note that recalibration should be performed after moving subwoofers. When you do this, leave about 10 cm (4 in) of space between the subwoofer and the wall. The acoustic reflections from the side walls in the room can also cause this problem. To fix this, try moving the subwoofer closer to the side wall or towards a corner.”

The same recommendation could be given, if the subwoofer would demonstrate dips at a certain frequency range.

As a further example, if the tolerance for the level of low frequency notches was set at −10 dB relative to the average level of frequency response, the library could include a pre-determined installation change recommendation for a loudspeaker that has low frequency notches greater than −10 dB. Let us assume that a full bandwidth loudspeaker would demonstrate a low frequency notch of −15 dB below 200 Hz, the library could include the following installation change recommendation: “We are observing a wide loss of sound level (also called a dip) below 200 Hz. This typically causes the feeling that the system bass response is lacking or poor. A dip can be caused by an acoustic reflection from the nearest wall, typically behind a monitor. Recommendation: To remove this problem, try moving the monitor closer to the wall. Doing so will move cancellation frequencies up to a value where the monitor mainly radiates audio in the forward direction, so the effect of the back wall is minimised. Alternatively, move the monitors far away from the walls. This reduces the level of reflected audio, and makes the acoustic effect less detectable. For this approach, the monitors should be more than 1.1 metres (4 ft) from the nearest wall. You can also consider moving your listening position. This can help if the acoustic problem is only audible at a certain location in the room. When the dip is caused by audio reflecting off the side walls, you can reduce the level of reflection by adding absorption or diffusion materials on the reflecting surfaces. Note that recalibration of the monitors should be performed whenever the monitors or the listening position have been moved. A sufficiently thick absorbing layer is needed for lower frequencies, where the audio wavelength is long. When the dips are caused by reflections from the ceiling and floor, moving the monitor locations up or down may help. A very effective absorbing method for specific frequencies only is the Helmholtz resonator absorber.”

As a further example, the library could include a pre-determined installation change recommendation for a loudspeaker that has a reverberation time (RT60) value greater or smaller than a given time for a given frequency in a particular listening volume. The RT60 tolerance may be derived from contemporary or list of recommendations, such as ITU-R BS.1116. According to the ITU-R recommendation an average value of reverberation Tm measured over a frequency range 200 Hz to 4 kHz is Tm=0.25 (V/V0)⅓, where V is the volume of the listening room and V0 is a reference volume of 100 m3. The tolerance varies across the frequency spectrum. For example at 100 Hz, positive RT60 tolerance is +0.3 s and negative tolerance is −0.05 s. At 500 Hz, the RT60 tolerance is symmetric at 0.05 s. At 5000 Hz, the RT60 tolerance is symmetric at 0.1 s.

Let us assume that a full bandwidth loudspeaker would demonstrate an RT60 value of 0.95 s at 400 Hz, the library could include the following installation change recommendation: “The reverberation time is high. When the reverberation time is high, this can prevent you from hearing the colour and dynamics in the sound correctly. You may also hear more of the reverberant sound than the direct sound, depending on your listening distance. This can lead to poor clarity of sound and acoustic masking caused by the reflection. Recommendation: Check the early-to-late sound ratio in the table below (not shown). If the early sound is higher than 3 dB relative to the late sound, then direct sound will tend to dominate at your monitoring location, and the value of the room reverberation time may be less critical. Adding acoustic absorption in the room can reduce the reverberation time. When this is done, the reverberation time should remain similar across frequencies. You can improve the early-to-late sound ratio by moving your monitors closer to the listening position, and this can reduce the importance of the room reverberation time.”

As a further example, if the tolerance for early to late sound ratio was set at 0 dB, meaning that late sound level is equal or larger than early sound level, the library could include a pre-determined installation change recommendation for a loudspeaker that has an early to late sound ratio value lower than 0 dB. Let us assume that a full bandwidth loudspeaker would demonstrate an early to late sound ratio value of −1 dB, the library could include the following installation change recommendation: “The late sound level in the room is dominating the sound character. When the early-to-late sound ratio is less than 3 dB then early sound, containing mainly the direct sound, can no longer determine the sound character at your listening position. Then, the reverberation time in the room has a strong influence on how you hear sound. When the reverberation across frequencies is not similar, and the sound decays slower at certain frequencies (called room mode resonances), this can cause significant masking that hides nuances in audio and changes how you hear the recorded audio dynamics. Recommendation: Solving this problem involves reducing the reverberation in the room, and increasing the level of direct sound. Reverberation can be reduced by adding acoustically absorbent material in the room. In some cases, active sound absorbers can also be used. After adding absorption, the sound decay time should be similar across frequencies. To increase the level of direct sound, try moving your monitors closer.”

Other parameters that could be observed include decay time of room modes or resonances, the sum response of a subwoofer and full range loudspeakers, −6 dB points, and time of flight.

The analysis step could also involve the use of several parameters through AND and/or OR operators. More specifically, the analysis algorithm could make use of a primary parameter and a secondary parameter. For example, let us assume that early-to-late-sound ratio was selected as the primary parameter and RT60 was selected as the secondary parameter, the user could be informed whether to improve the performance of the loudspeaker system 100 by decreasing the listening distance or adding damping material to the listening room. The computing algorithm could determine that:
if the primary parameter value was smaller than the threshold AND the secondary parameter value was greater than the threshold, the library could output the following statement: “Your RT60 is high and early-to-late-sound ratio low. Reduce RT60 by having more damping material in your room.”
(else) if the primary parameter value was smaller than the threshold AND the secondary parameter value was lower than the threshold, the library could output the following statement: “Your RT60 is low and early-to-late-sound ratio low. Move loudspeaker or listening position to have shorter listening distance. This will improve early-to-late-sound ratio.”
(else) The library could output the following statement: “Your early-to-late-sound ratio is acceptable.”

The indication of non-compliance is stored 1037 for each non-compliant value together with the associated installation change recommendation.

The results for each parameter 1 . . . n, both those that comply and those that do not comply to the pre-determined tolerance, are compiled 1038 to a report, which is then transmitted 1039 back to the control system 200 through the communication interfaces 402, 202 and presented to the user through the user interface 203. The report may show the actual realized result of the performance of the loudspeaker system 100 or a calculated result based on mathematical approximations and/or projections.

If all parameters are within specification, the user will receive data-based validation that the loudspeaker installation is in compliance with the standard, against which the loudspeaker system 100 was tested. However, if the loudspeaker system 100 falls short in one or more than one parameter, the user is informed of changes he can make to the installation to improve performance. The suggestions are based on measured audio data and educated solutions pre-defined into the helper database 405. With such a tool at his disposal, the user is more likely to soon find a well performing setup than without such data-based assistance.

After the user has changed the physical installation of the loudspeaker system 100, such as by changing the location and/or orientation of one or more than one loudspeaker in the loudspeaker system, he can verify the effects of the setup change by repeating the process.

As an alternative to a pre-determined thresholds for a set of audio parameters, a comparable approach would be to base the helper algorithm to a set of historical values for selected audio parameters. For example, the system and method could be modified to determine, which of a plurality of alternative subwoofer locations or which distance of full range loudspeakers from a back wall would provide the best result. An alternative analysis step could first include the provision of a plurality of audio data sets each representative of the performance of the loudspeaker system (100) in a corresponding plurality of different installations, such as the afore-mentioned subwoofer or full range loudspeaker placements. The analysis stage could involve extracting a value for at least one audio parameter from the plurality audio data sets, comparing each of the values extracted from the plurality audio data sets to each other and to a predetermined target value, and based on the comparison step, selecting the audio data set, which has a value of the least one audio parameter closest to the predetermined target value, as the recommended installation. The historical audio data may be stored locally in the loudspeaker, in the control system or in the computing system. The optional calibration stage, data transfer stage between the systems, and the outputting stage can be similar between the criteria database and the historical data embodiments.

The report, which is the output of the process, should be understood broadly. The report can take the form of a classic document, such as a PDF summary of the combined results. Alternatively, the report may take the form of an iterative continual display of information using a graphical user interface showing live or relatively live info. Such a functionality may be incorporated into the user interface 203 of the control system 200.

It should also be pointed out that the analysis described in connection with the criteria database and the historical data embodiments may or may not be preceded by a calibration stage or several calibration stages. This means that an installation analysis may be performed independently from a conventional room calibration of loudspeaker presets.

According to an alternative embodiment, the microphone is incorporated into one or more than one loudspeaker in the loudspeaker system.

According to an alternative embodiment, the databases may be stored locally into the control system, which may or may not perform the processing required for the analysis. Additionally or alternatively, the loudspeaker may include the processing and/or storing resources required to perform part or all of the analysis.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

### REFERENCE SIGNS LIST

| NO. | FEATURE |
|---|---|
| 100 | loudspeaker system |
| 101 | loudspeaker |
| 102 | loudspeaker |
| 103 | loudspeaker |
| 200 | control unit |
| 201 | controller |
| 202 | communication interface |
| 203 | user interface |
| 300 | microphone |
| 400 | computing system |
| 401 | processor |
| 402 | communication interface |
| 403 | memory |
| 404 | first database, e.g. criteria database |
| 405 | second database, e.g. helper database |
| 406 | signal interface |
| 1010 | first calibration step |
| 1011 | reproducing a test signal |
| 1012 | measuring a response |
| 1013 | calibrating |
| 1020 | second calibration step |
| 1021 | reproducing a test signal |
| 1022 | measuring a response |
| 1023 | calibrating |
| 1030 | installation analysis step |
| 1031 | starting analysis |
| 1032 | extracting audio parameter values |
| 1033 | comparing values against criteria database |
| 1034 | checking whether value within tolerance |
| 1035 | producing an indication of compliance |
| 1036 | querying helper database |
| 1037 | producing an indication of non-compliance and installation change |
| | recommendation |
| 1038 | compiling results into a report |
| 1039 | reporting |

1. A method of producing a report for optimizing an installation of a loudspeaker system (100) comprising at least one loudspeaker (101, 102, 103) in a monitoring space, the method comprising:
providing audio data representative of the performance of the loudspeaker system (100),
performing an analysis (1030), which comprises:
extracting (1032) a value for at least one audio parameter (1 . . . n) from the audio data,
comparing (1033) the extracted value to a criteria database (404), which comprises a tolerance for the at least one audio parameter (1 . . . n),
if the value being analyzed is within the associated tolerance, storing (1035) an indication of compliance for the corresponding audio parameter (1 . . . n),
if the value being analyzed is not within the associated tolerance, querying (1036) a helper database (405) for an installation suggestion for said value as well as storing (1037) an indication of non-compliance for the corresponding audio parameter (1 . . . n) and the associated installation suggestion, and
compiling (1038) the stored results, and
outputting (1039) the compiled results.

2. The method according to claim 1, wherein the analysis (1030) comprises performing an analysis on a plurality of audio parameters (1 . . . n).

3. The method according to claim 1 or 2, wherein the analysis (1030) is performed at least in part in an computing system (400) external to the loudspeaker system (100).

4. The method according to claim 3, wherein the computing system (400) is connected to the loudspeaker system (100) through a data communication interface (202, 402) between the computing system (400) and a control system (200), which is connected to the loudspeaker system (100).

5. The method according to any one of the preceding claims, comprising a calibration step (1010) comprising:
in a test signal step, reproducing (1011) an audio test signal with at least one loudspeaker (101, 102, 103),
in a listening step, capturing (1012) the reproduced audio test signal with a microphone (300) located in the monitoring space, and
calibrating the loudspeaker system (100) based on the captured audio test signal.

6. The method according to any one of the preceding claims, wherein the method comprises a second such calibration step (1020).

7. The method according to any one of the preceding claims, wherein the audio parameter (1 . . . n) is selected from a list comprising or consisting of:
frequency response,
−6 dB points,
time of flight,
summation of frequency response of a plurality of loudspeakers,
subwoofer high cut-off frequency,
low frequency dip in (full bandwidth) monitors,
early to late sound ratio,
decay time of room mode,
subwoofer and (full bandwidth) monitor sum response dip,
early reflection level, and
reverberation time (RT60).

8. The method according to any one of the preceding claims, wherein the outputting step (1039) comprises displaying compliance of each audio parameter (1 . . . n) to a pre-determined criteria set for those parameters.

9. A method of producing a report for optimizing an installation of a loudspeaker system (100) comprising at least one loudspeaker (101, 102, 103) in a monitoring space, the method comprising:
providing a plurality of audio data sets representative of the performance of the loudspeaker system (100) in a corresponding plurality of different installations,
performing an analysis, which comprises:
extracting a value for at least one audio parameter from the plurality audio data sets,
comparing each of the values extracted from the plurality of audio data sets to each other and to a predetermined target value,
based on the comparison step, selecting the audio data set, which has a value of at least one audio parameter closest to the predetermined target value, as the recommended installation, and
compiling (1038) the stored results, and
outputting (1039) the compiled results.

10. The method according to claim 9, being further characterized by the features of any one of the preceding claims 2 to 7.

11. A method of optimizing an installation of a loudspeaker system (100) comprising said at least one loudspeaker (101, 102, 103) in a monitoring space, the method comprising performing the steps as defined in any one of the preceding claims 1 to 10, wherein if the report includes an installation change suggestion, performing the suggested physical installation change as an adjustment step.

12. The method according to claim 11, wherein the computing steps according to any one of the preceding claims 1 to 10 is performed in an external computing system, such as a cloud-based computing system, and wherein the adjustment step is performed physically in the listening space.

13. An computing system (400), comprising:
a processor (401),
a memory (403) connected to the processor (401), the memory (403) having stored thereon a set of computer readable instructions causing, when executed by the processor (401), the processor (401) to perform the processing steps of any one of the preceding claims 1 to 7,
a data communication interface connected to the processor (401) and configured to receive audio data from a loudspeaker system (100),
a criteria database (404) directly or indirectly connected to the processor (401), which criteria database (404) comprises a library of tolerances for at least one audio parameter (1 . . . n), and
a helper database (405) directly or indirectly connected to the processor (401), which helper database (405) comprises a library of installation change suggestions for a plurality of pre-determined non-compliances with tolerances for the at least one audio parameter (1 . . . n).

14. The computer system (400) according to claim 13, further comprising an interface for outputting the report

15. A non-transitory computer readable medium having stored thereon a set of computer readable instructions that, when executed by at least one processor (401), cause an apparatus to perform the processing steps of any one of the preceding claims 1 to 10.

16. A computer program configured to cause a method in accordance with at least one of claims 1 to 10 to be performed on a computing unit.
